(19) United States
(12) Patent Application Publication
(10) Pub. No.: US 2013/0268675 A1
(43) Pub. Date: Oct. 10, 2013

(54) Method and System for Tracing Domain Names and Computer Readable Storage Medium Storing the Method

(71) Applicants: Meng-Han Tsai, Tainan City (TW); Chang-Cheng Lin, New Taipei City (TW); Kai-Chi Chang, Keelung City (TW); Ching-Hao Mao, Taipei City (TW)

(72) Inventors: Meng-Han Tsai, Tainan City (TW); Chang-Cheng Lin, New Taipei City (TW); Kai-Chi Chang, Keelung City (TW); Ching-Hao Mao, Taipei City (TW)

(73) Assignee: INSTITUTE FOR INFORMATION INDUSTRY, Taipei (TW)

(21) Appl. No.: 13/544,068

(22) Filed: Jul. 9, 2012

(30) Foreign Application Priority Data
Apr. 5, 2012 (TW) 101112078

(51) Int. Cl. G06F 15/173

(52) U.S. Cl. 709/226

(57) ABSTRACT

A method for tracing at least one domain name is disclosed. In the method, several DNS resource records of candidate domain names are queried from at least one DNS name server. The candidate domain names are domain names that need to be traced. Internet Protocol (IP) addresses associated with the candidate domain names are retrieved from the DNS resource records of the candidate domain names. At least one external resource server is connected to retrieve corresponding registration information of the respective IP addresses of the candidate domain names. A tracing weight of each of the candidate domain names is calculated according to the DNS resource records, the IP addresses and the corresponding registration information of the candidate domain names. The candidate domain names are traced according to their respective tracing weights. A system for tracing at least one domain name is also disclosed.

### RELATED APPLICATIONS

This application claims priority to Taiwan Application Serial Number 101112078, filed Apr. 5, 2012, which is herein incorporated by reference.

### BACKGROUND

1. Technical Field

The present invention relates to a method and system for tracing at least one domain name and a computer readable storage medium for storing the method, more particularly, to a method and system for tracing at least one domain name according to its corresponding tracing weight, which is calculated according to the information associated with the domain name, and a computer readable storage medium for storing the method.

2. Description of Related Art

Phishing is a way of attempting to acquire sensitive information such as usernames, passwords, and credit card details in an electronic communication by masquerading as a trustworthy entity. For example, phishing Web pages often disguise themselves as famous social networking Web pages (e.g., YouTube®, Facebook®, MySpace®, etc.), bidding Web pages (e.g., Ebay®), network banks, e-commerce Web pages (e.g., PayPal®), network management Web pages (e.g., Yahoo®, network service providers, companies, institutions) to deceive users into thinking phishing Web pages are legitimate. Subsequently, the users are directed to a Web page with similar Uniform Resource Locator (URL) or interfaces substantially the same as the Web site they claim to be but actually in malicious domain names, so as to steal their private or secret information. Even if authorization utilizing Secure Sockets Layer (SSL) protocol is verified, it is still difficult to identify whether Web pages are fake or not.

Such malicious attacks often utilize domain name generating algorithms to generate several domain names for providing malwares or malicious Web pages. In that massive amount of the malicious domain names can be generated, even parts of malicious domain names are blocked, there are still plenty of them for malicious use. In the prior art, malicious domain name tracing or monitoring are often performed between a Recursive Domain Name System (RDNS) server and a monitored network, according to Domain Name System (DNS) traffic analysis, which causes issues of privacy infringement against the users. In addition, it is mostly required for tracers or monitors installed in such monitored network to perform the tracing or monitoring; however, it is impractical to install or set up a large amount of tracers or monitors in different monitored network.

### SUMMARY

According to one embodiment of this invention, a method for tracing at least one domain name is disclosed to obtain DNS resource records, Internet Protocol (IP) addresses and corresponding registration information of the respective IP addresses of candidate domain names for calculating tracing weights of the candidate domain names, and traces the candidate domain names according to their tracing weights. The method for tracing at least one domain name includes the following steps:

(a) several DNS resource records of several candidate domain names are queried from at least one DNS name server. The candidate domain names are domain names that need to be traced.

(b) several IP addresses are retrieved from the DNS resource records of the candidate domain names.

(c) at least one external resource server is connected to retrieve corresponding registration information of the respective IP addresses of the candidate domain names.

(d) a tracing weight of each of the candidate domain names is calculated according to the DNS resource records, the IP addresses and the corresponding registration information of the candidate domain names.

(e) the candidate domain names are traced according to their respective tracing weights.

According to another embodiment of this invention, a computer readable storage medium is disclosed to store a computer program for executing a method for tracing at least one domain name. Steps of the method are as disclosed above.

According to another embodiment of this invention, a system for tracing at least one domain name is disclosed to obtain DNS resource records, IP addresses and corresponding registration information of the respective IP addresses of candidate domain names for calculating tracing weights of the candidate domain names, and traces the candidate domain names according to their tracing weights. The system includes at least one Network Interface Controller (NIC) and a processing unit, which are electrically connected to each other. The NIC builds a connection with at least one network. The processing unit includes a querying module, an information retrieving module, a weight calculating module and a tracing module. The querying module queries several DNS resource records of several candidate domain names from at least one DNS name server through the network. The querying module retrieves several IP addresses from the DNS resource records of the candidate domain names. The information retrieving module connects to at least one external resource server through the network to retrieve corresponding registration information of the respective IP addresses of the candidate domain names. The weight calculating module calculates a tracing weight of each of the candidate domain names according to the DNS resource records, the IP addresses and the corresponding registration information of the candidate domain names. The tracing module traces the candidate domain names according to their respective tracing weights.

The present invention can achieve many advantages. The strategies of tracing the candidate domain names can be adjusted without monitoring the DNS traffic associated with the candidate domain names between a RDNS server and a monitored network, which, therefore, can avoid invasion of privacy of users. Moreover, in one embodiment of this invention, the present invention can be applied to the server other than RDNS server. In other words, there is unnecessary to install or set up extra servers in different monitored networks, which can save costs. Furthermore, if the present invention is applied, the formats of domain names, which can be traced, may not be limited.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram will be described that illustrates a method for tracing at least one domain name according to one embodiment of this invention; and

FIG. 2 illustrates a block diagram of a system for tracing at least one domain name according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

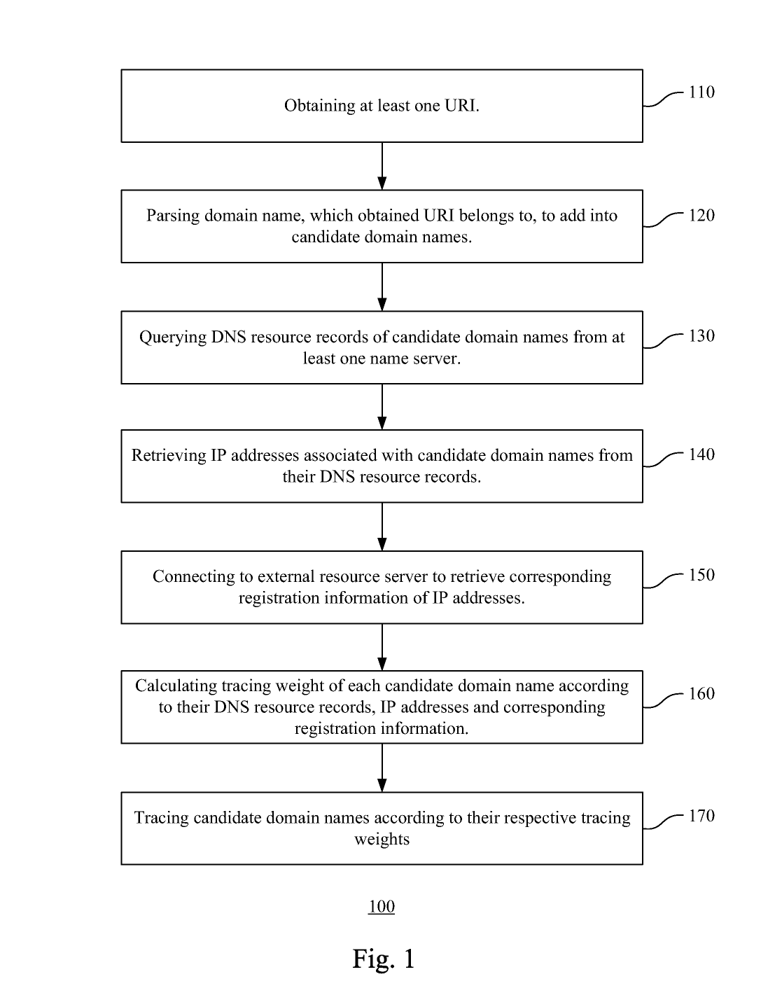

Referring to FIG. 1, a flow diagram will be described that illustrates a method for tracing at least one domain name according to one embodiment of this invention. In the method, DNS resource records, IP addresses and corresponding registration information of the respective IP addresses of candidate domain names are obtained for calculating tracing weights of the candidate domain names, and the candidate domain names are traced according to their tracing weights. The method may take the form of a computer program product stored on a computer-readable storage medium having computer-readable instructions embodied in the medium. Any suitable storage medium may be used including non-volatile memory such as Read Only Memory (ROM), Programmable Read Only Memory (PROM), Erasable Programmable Read Only Memory (EPROM), One Time Programmable Read Only Memory (OTPROM) and Electrically Erasable Programmable Read Only Memory (EEPROM) devices; volatile memory such as Static Random Access Memory (SRAM), Dynamic Random Access Memory (DRAM), and Double Data Rate Random Access Memory (DDR-RAM); optical storage devices such as Compact Disc Read Only Memories (CD-ROMs) and Digital Versatile Disc Read Only Memories (DVD-ROMs); and magnetic storage devices such as Hard Disk Drives (HDD) and floppy disk drives.

The method 100 for tracing at least one domain name includes the following steps:

At step 130, several DNS resource records of several candidate domain names are queried from at least one name server. The candidate domain names are domain names that need to be traced. The queried name servers may include at least one DNS name server, at least one caching server, at least one top level server, at least one root server, or any other type of name server, or combination thereof.

In one embodiment of this invention, an internal database may pre-store the necessary information of the candidate domain names for querying at step 130.

In another embodiment of this invention, at least one Uniform Resource Identifier (URI) can be obtained from an external resource server at step 110. In some embodiments, when the present invention is applied to trace malicious domain names, at least one malicious URI may be set as the URI to be obtained, malicious domain names may be set as the candidate domain names, and the external resource server for providing the malicious URI may be a honeypot system, a blacklist database, a DNS, a WHOIS database or any other database which is able to provide information of malicious URI. Subsequently, a domain name, which the obtained URI belongs to, is parsed to add into the candidate domain names at step 120, such that querying at step 130 can be performed in subsequence. Therefore, by the above embodiments for adding new candidate domain names, domain name tracing can be performed even if there is few or none candidate domain name in advance. In other words, in some embodiments, it is unnecessary to have training data set for tracing candidate domain names in advance. Moreover, if there is one of the candidate domain names is the same as the domain name, which the obtained URI belongs to, such domain name may be eliminated without repeatedly processing.

In still another embodiment, only a pre-defined number of the candidate domain names may be selected for further processing at the following steps. Therefore, by reducing the number of the candidate domain names for tracing, resource and time for executing the method in the present invention can be saved.

At step 140, several IP addresses associated with the candidate domain names are retrieved from the DNS resource records of the candidate domain names. In one embodiment of step 140, the respective IP addresses associated with the candidate domain names can be retrieved from the IP address columns of the respective resource records or any other type of address column of the respective resource records.

At step 150, at least one external resource server is connected to retrieve corresponding registration information of the respective IP addresses of the candidate domain names. In some embodiments of step 150, WHOIS protocol can be utilized to retrieve the corresponding registration information of the respective IP addresses of the candidate domain names from the external resource server. The retrieved registration information of the respective IP addresses may include Autonomous System Number (ASN), Country Code (CC), Internet Service Provider (ISP) or any other registration information which can be retrieved through WHOIS protocol.

At step 160, a tracing weight of each of the candidate domain names is calculated according to the DNS resource records, the IP addresses and the corresponding registration information of the candidate domain names.

At step 170, the candidate domain names are traced according to their respective tracing weights. In one embodiment of step 170, the candidate domain name with a high tracing weight can be traced with a high frequency; the candidate domain name with a low tracing weight can be traced with a low frequency. In other embodiments of step 170, the method for tracing the candidate domain names may differ according to their respective tracing weights, which should not be limited in this disclosure. Therefore, the strategies of tracing the candidate domain names can be adjusted without monitoring the DNS traffic associated with the candidate domain names between a RDNS server and a monitored network, which, therefore, can avoid invasion of privacy of users. Moreover, in one embodiment of this invention, the present invention can be applied to the server other than RDNS server.

In another embodiment of step 170, at least one tracing condition may be received. Subsequently, the condition is matched with any member of the DNS resource records, the IP addresses and the corresponding registration information, according to the tracing weights of the candidate domain names. If matching, listing details of the candidate domain names that match the tracing condition to an output table. The listed details may include the DNS resource records, the IP addresses and the corresponding registration information. For example, when the tracing condition includes a country code of a specific country, the candidate domain names, the registered country code of which matches the specific country, can be listed to the output table for tracing at step 170. Therefore, after filtering the traced domain names according to the tracing condition, the result of tracing at step 170 can fit users' requirement.

After step 170, step 110 to step 170 may be continually performed. Therefore, suspicious domain names may be continually traced, whereas some domain names can be eliminated without being traced, which gives a precise tracing result.

In one embodiment of step 160, an analysis algorithm may be utilized to analyze the DNS resource records, the IP addresses and the corresponding registration information of the candidate domain names to calculate the tracing weight for each of the candidate domain names. Such analysis algorithm may be Support Vector Machine (SVM) algorithm, artificial neural network algorithm, K-Nearest Neighbors (KNN), Naïve Bayes algorithm, Decision Tree algorithm or any other algorithm for weight analyzing. In other embodiments, the analysis algorithm may provide intelligence which automatically optimizes multiple variable combination according to the past observation for measuring the activities of the domain names.

In one embodiment of this invention, the DNS resource records of the candidate domain names may include the related value of Top Level Domain (TLD) of the candidate domain names. In some embodiments at step 160, the analysis algorithm may give a high tracing weight to the candidate domain name with more valuable TLD. In another embodiment at step 160, the analysis algorithm may compare current TLD value of a candidate domain name with another candidate domain name's TLD value, and the candidate domain name, the current TLD value of which is more valuable than another TLD value of the same, may be given a high tracing weight.

In another embodiment of this invention, a DNS resource record may include a number of authoritative name servers for the corresponding candidate domain name. In some embodiments, at step 160, the analysis algorithm may give a high tracing weight to the candidate domain name, the number of authoritative name servers for which is large. In another embodiment at step 160, the analysis algorithm may compare a current number of authoritative name servers for a candidate domain name with a previous number of authoritative name servers for the same, and the candidate domain name, the current number of authoritative name servers for which is more than the previous number of authoritative name servers for the same, may be given a high tracing weight.

In another embodiment of this invention, the analysis algorithm may give a high tracing weight to the candidate domain name, the number of IP addresses for which is large, at step 160. In still another embodiment of this invention, the analysis algorithm may compare a current number of IP addresses for a candidate domain name with a previous number of IP addresses for the same, and the candidate domain name, the current number of IP addresses for which is more than the previous number of IP addresses for the same, may be given a high tracing weight.

In another embodiment of this invention, a DNS resource record may include a spatial feature of the corresponding candidate domain name, such as the number of ASN of the corresponding candidate domain name, the number of CC of the corresponding candidate domain name, the number of ISP of the corresponding candidate domain name. In one embodiment of step 160, the analysis algorithm may give a high tracing weight to the candidate domain name, the number of ASN, CC, ISP or any other spatial feature of which is large, at step 160. In another embodiment, the analysis algorithm may compare a current number of ASN, CC, ISP or any other spatial feature of a candidate domain name with a previous number of the same, and the candidate domain name, the current number of such spatial feature for which is more than the previous number of the same, may be given a high tracing weight.

In another embodiment of this invention, a DNS resource record may include a temporal feature of the corresponding candidate domain name, such as Time to Live (TTL), recent active period or any other temporal feature. In some embodiments, the analysis algorithm may give a high tracing weight to the candidate domain name, the value of temporal feature of which is large, at step 160. In other embodiments, above embodiments for calculating tracing weights of the candidate domain names at step 160 may be integrated or other method for calculating the tracing weights may be utilized, which should not be limited in this disclosure.

Moreover, in the method 100, if the DNS resource records, the IP addresses, or the corresponding registration information of the respective IP addresses changes, the corresponding columns in the database can be updated.

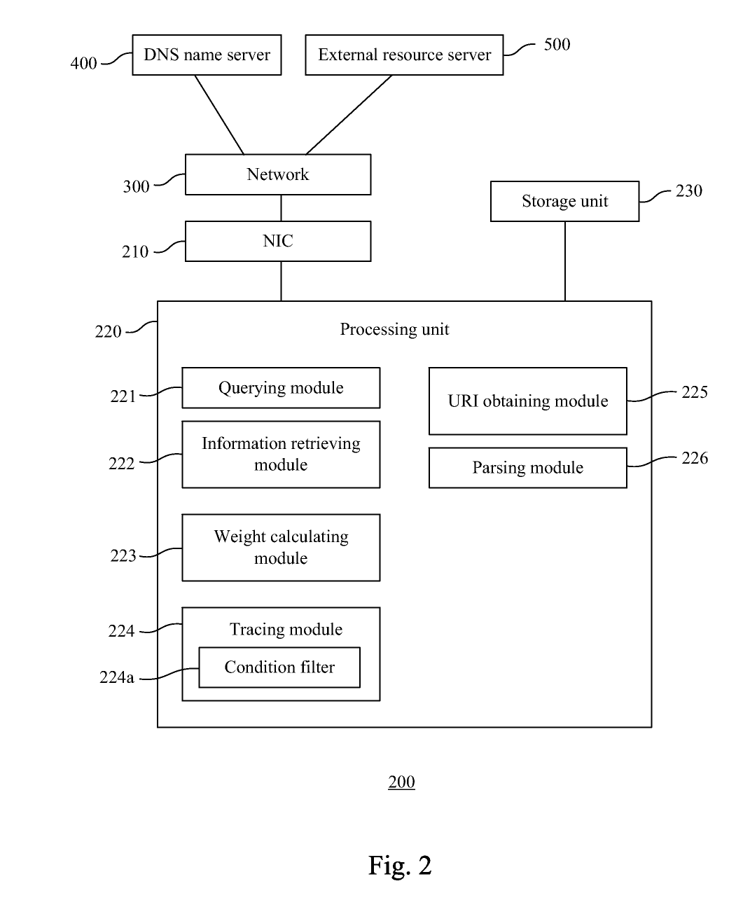

FIG. 2 illustrates a block diagram of a system for tracing at least one domain name according to an embodiment of this invention. The system obtains DNS resource records, IP addresses and corresponding registration information of the respective IP addresses of candidate domain names for calculating tracing weights of the candidate domain names, and traces the candidate domain names according to their tracing weights.

The system 200 includes at least one NIC 210 and a processing unit 220, which are electrically connected to each other. The NIC 210 builds a connection with at least one network 300 through a wired or wireless network protocol.

The processing unit 220 includes a querying module 221, an information retrieving module 222, a weight calculating module 223 and a tracing module 224. The querying module 221 queries several DNS resource records of several candidate domain names from at least one name server 400 through the network 300. In one embodiment of this invention, the system 200 may further include a storage unit 230, which is electrically connected to the processing unit 220. The storage unit 230 stores necessary information of the candidate domain names to provide the querying module 221 for querying from the DNS name server 400.

In another embodiment of this invention, the processing unit 220 may further include an URI obtaining module 225 and a parsing module 226. The URI obtaining module 225 obtains at least one URI from at least one external resource server 500 through the network 300. In some embodiments, if the system 200 is applied to trace malicious domain names, the URI obtaining module 225 may obtain at least one malicious URI as the obtained URI, the system 200 may take malicious domain names as the candidate domain names, and the external resource server 500 for providing the malicious URI may be a honeypot system, a blacklist database, a DNS, a WHOIS database or any other database which is able to provide information of malicious URI. The parsing module 226 parses the domain name, which the obtained URI belongs to, to add into the candidate domain names for further processing. Moreover, if there is one of the candidate domain names is the same as the domain name, which the obtained URI belongs to, the processing unit 220 may eliminate such domain name without repeatedly processing.

In addition, the processing unit 220 may select only a pre-defined number of the candidate domain names in the storage unit 230 for further processing. Therefore, by reducing the number of the candidate domain names for tracing, resource of the system 200 and time for executing the method in the present invention can be saved.

Subsequently, the querying module 221 retrieves several IP addresses of the candidate domain names from the DNS resource records of the candidate domain names. In one embodiment, the querying module 221 may retrieve the respective IP addresses of the candidate domain names from the IP address columns of the corresponding resource records or any other type of address column of the corresponding resource records.

The information retrieving module 222 connects to the external resource server 500 through the network 300 to retrieve corresponding registration information of the respective IP addresses of the candidate domain names. In some embodiments, the information retrieving module 222 may utilize WHOIS protocol to retrieve the corresponding registration information of the respective IP addresses from the external resource server 500. The retrieved registration information of the IP addresses may include ASN, CC, ISP or any other registration information which can be retrieved through WHOIS protocol.

The weight calculating module 223 calculates a tracing weight of each of the candidate domain names according to the DNS resource records, the IP addresses and the corresponding registration information of the candidate domain names. The weight calculating module 223 may utilize an analysis algorithm to analyze the DNS resource records, the IP addresses and the corresponding registration information of the respective IP addresses to calculate the tracing weight. Such analysis algorithm may be SVM algorithm, artificial neural network algorithm, KNN, Naïve Bayes algorithm, Decision Tree algorithm or any other algorithm for weight analyzing.

The tracing module 224 traces the candidate domain names according to their respective tracing weights. In one embodiment of this invention, the tracing module 224 may trace the candidate domain name with a high tracing weight with a high frequency; the tracing module 224 may trace the candidate domain name with a low tracing weight with a low frequency. In other embodiments, the tracing module 224 may utilize different tracing strategies according to their respective tracing weights, which should not be limited in this disclosure. Therefore, the system 200 can utilize different strategies for tracing different candidate domain names without monitoring the DNS traffic associated with the candidate domain names between a RDNS server and a monitored network, which, therefore, can avoid invasion of privacy of users. Moreover, in one embodiment of this invention, the system 200 can be implemented utilizing the server other than DNS. In some other embodiments, the tracing module 224 may transmit the tracing weights of the candidate domain names to other servers for tracing, such that other servers can adjust their tracing strategy according to the received tracing weights.

Moreover, the tracing module 224 may further include a condition filter 224a. The condition filter 224a receives at least one tracing condition. Subsequently, the condition filter 224a may drive the tracing module 224 to match the condition with any member of the DNS resource records, the IP addresses and the corresponding registration information, according to the tracing weights of the candidate domain names. If matching, the condition filter lists details of the candidate domain names that match the tracing condition to an output table. The listed details may include the resource records, the IP addresses and the corresponding registration information. Therefore, after filtered according to the tracing condition, the tracing module 224 can list the domain names which fit users' requirement.

Furthermore, the querying module 221, the information retrieving module 222, the weight calculating module 223 and the tracing module 224 may keep tracing the candidate domain names according to their newly calculated tracing weights. Therefore, suspicious domain names may be continually traced, whereas some domain names can be eliminated without being traced, which gives a precise tracing result.

The present invention can achieve many advantages. The strategy for tracing the candidate domain names can be adjusted without monitoring the DNS traffic associated with the candidate domain names between a RDNS server and a monitored network, which, therefore, can avoid invasion of privacy of users. Moreover, in one embodiment of this invention, the present invention can be applied to the server other than RDNS server. In other words, there is unnecessary to install or set up extra servers in different monitored networks, which can save costs. Furthermore, if the present invention is applied, the formats of domain names, which can be traced, may not be limited.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for tracing at least one domain name, comprising:
(a) querying a plurality of Domain Name System (DNS) resource records of a plurality of candidate domain names from at least one DNS name server, said plurality of candidate domain names being domain names that need to be traced;
(b) retrieving a plurality of Internet Protocol (IP) addresses from said plurality of DNS resource records of said plurality of candidate domain names;
(c) connecting to at least one external resource server to retrieve corresponding registration information of the respective IP addresses of said plurality of candidate domain names;
(d) calculating a tracing weight of each of the candidate domain names according to the DNS resource records, the IP addresses and the corresponding registration information of said plurality of candidate domain names; and
(e) tracing the candidate domain names according to their respective tracing weights.

2. The method of claim 1, further comprising:
obtaining at least one Uniform Resource Identifier (URI); and
parsing at least one domain name from the URI to add into the candidate domain names.

3. The method of claim 1, wherein step (e) comprises:
receiving at least one tracing condition; and
matching the condition with any member of the DNS resource records, the IP addresses and the corresponding registration information, according to the tracing weights of the candidate domain names; and
when matching, listing details of the candidate domain names that match the tracing condition,
wherein the details comprises the resource records, the IP addresses and the corresponding registration information.

4. The method of claim 1, wherein step (d) comprises:
utilizing an analysis algorithm to analyze the DNS resource records, the IP addresses and the corresponding registration information to calculate the tracing weight for each of the candidate domain names.

5. The method of claim 4, wherein the analysis algorithm provides intelligence for measuring the activities of the domain names.

6. The method of claim 1, wherein the candidate domain names are a plurality of malicious domain names.

7. The method of claim 1, wherein step (a) comprises querying a caching server.

8. The method of claim 1, wherein step (a) comprises querying a top level server.

9. The method of claim 1, wherein step (a) comprises querying a root server.

10. A system for tracing at least one domain name, comprising:
at least one Network Interface Controller (NIC) for building a connection with at least one network; and
a processing unit electrically connected to the NIC, wherein the processing unit comprises:
a querying module for querying a plurality of DNS resource records of a plurality of candidate domain names from at least one DNS name server through the network, and retrieving a plurality of IP addresses from said plurality of DNS resource records of said plurality of candidate domain names;
an information retrieving module for connecting to at least one external resource server through the network to retrieve corresponding registration information of the respective IP addresses of said plurality of candidate domain names;
a weight calculating module for calculating a tracing weight of each of the candidate domain names according to the DNS resource records, the IP addresses and the corresponding registration information of said plurality of candidate domain names; and
a tracing module for tracing the candidate domain names according to their respective tracing weights.

11. The system of claim 10, wherein the processing unit further comprises:
an URI obtaining module for obtaining at least one URI through the network; and
a parsing module for parsing a domain name from the URI to add into the candidate domain names.

12. The system of claim 10, wherein the tracing module comprises:
a condition filter for receiving at least one tracing condition and for driving the tracing module to match the condition with any member of the DNS resource records, the IP addresses and the corresponding registration information, according to the tracing weights of the candidate domain names,
when matching, the condition filter listing details of the candidate domain names that match the tracing condition,
wherein the details comprises the resource records, the IP addresses and the corresponding registration information.

13. The system of claim 10, wherein the weight calculating module utilizes an analysis algorithm to analyze the DNS resource records, the IP addresses and the corresponding registration information to calculate the tracing weight for each of the candidate domain names.

14. A computer readable storage medium with a computer program to execute a method for tracing at least one domain name, wherein the method comprises:
(a) querying a plurality of DNS resource records of a plurality of candidate domain names from at least one DNS name server, said plurality of candidate domain names being domain names that need to be traced;
(b) retrieving a plurality of IP addresses from said plurality of DNS resource records of said plurality of candidate domain names;
(c) connecting to at least one external resource server to retrieve corresponding registration information of the respective IP addresses of said plurality of candidate domain names;
(d) calculating a tracing weight of each of the candidate domain names according to the DNS resource records, the IP addresses and the corresponding registration information of said plurality of candidate domain names; and
(e) tracing the candidate domain names according to their respective tracing weights.
